(19) United States
(12) Patent Application Publication
(10) Pub. No.: US 2023/0319810 A1
(43) Pub. Date: Oct. 5, 2023

(54) Apparatus for Synchronizing Operation of Optical Sensors and a Method for Using Same

(71) Applicant: INUITIVE LTD., Ra'anana (IL)

(72) Inventor: Dor ZEPENIUK, Kfar Hess (IL)

(21) Appl. No.: 17/713,517

(22) Filed: Apr. 5, 2022

(51) Int. Cl. H04W 72/12; H04W 56/00

(52) U.S. Cl. CPC H04W 72/121; H04W 56/001

(57) ABSTRACT

A central platform is provided which is configured to operate in a system comprising a plurality of moveable devices, each comprising at least one optical depth sensor. The central platform is characterized in that it comprises a processor adapted to establish a time frame within which the plurality of optical depth sensors operate, and wherein that time frame includes a plurality of time slots, each allocated for the operation of a respective optical depth sensor.

### TECHNICAL FIELD

The present disclosure generally relates to systems and methods using optical devices, and more particularly, to improve performance of a plurality of devices each comprising an optical depth sensor.

### BACKGROUND

There are various scenarios in which a plurality of devices, each comprising an active depth sensor (e.g., robots, drones and the like), are operative within a confined space (e.g., in a warehouse). Under these scenarios, a projection module of an optical sensor comprised in one such a device will have an adverse effect on the sensing capabilities of an optical sensor comprised in another device, and consequently will cause have an undesirable impact upon the operation of the latter.

The present invention proposes a solution for implementing a new apparatus and a new method that enable operation of a plurality of such devices within a confined space, while mitigating potential interferences between the active optical sensors.

### SUMMARY OF THE DISCLOSURE

The disclosure may be summarized by referring to the appended claims.

It is an object of the present disclosure to provide an apparatus and a method to enable mitigating optical interferences between adjacent moveable devices operating within a physical proximity.

It is another object of the present disclosure to provide an apparatus and a method that enable synchronizing the operation of optical depth sensors of adjacent moveable devices.

It is another object of the present disclosure to provide an apparatus and a method for managing communications between that apparatus and moveable devices.

Other objects of the present invention will become apparent from the following description.

According to a first embodiment of the disclosure, there is provided a central unit (i.e., a central platform) configured to operate in a system that comprises a plurality of moveable devices, each comprising at least one optical depth sensor, wherein the central platform is characterized in that it comprises at least one processor adapted to establish a time frame within which at least two of the plurality of optical depth sensors comprised in a respective plurality of moveable devices, operate, and wherein that time frame comprises a plurality of time slots, each allocated for operation of a respective optical depth sensor, and wherein each optical depth sensor is operative during the time slot allocated thereto.

Typically, the system's moveable devices are operative within a confined space, thereby, inducing optical interferences between operating optical depth sensors comprised in adjacent moveable devices.

In accordance with another embodiment of the disclosure, the at least one processor is configured to determine a number of time frames per second, a length of each time frame and a number of a plurality of time slots to be allocated to the operating moveable devices.

By yet another embodiment, the at least one processor is further configured to synchronize operation of the plurality of optical depth sensors in accordance with the plurality of allocated time slots.

According to still another embodiment, the central platform further comprises a transmitter configured to enable communication between the plurality of moveable devices and the central unit in order to enable improved performance in operation of the moveable devices.

In accordance with another embodiment, the communication between the plurality of moveable devices and the central unit is adapted to enable synchronizing a start of time frames for the plurality of moveable devices and to overcome time: drifts while operating the plurality of moveable devices.

According to yet another embodiment of the disclosure, the communication between each of the plurality of moveable devices and the central unit is established every pre-defined period.

By still another embodiment, once a communication is established between the central unit and one of the plurality of moveable devices, the central unit is further configured to identify the moveable device being in communication with the central unit.

In an alternative embodiment, communications are broadcasted by the central unit to the plurality of moveable devices and wherein each of the communications includes an identification of a specific moveable device as well as information required for the operation of that 3 specific moveable device.

In accordance with another embodiment, the transmitter of the central unit is an optical transmitter, configured to transmit optical signals towards the plurality of the moveable devices.

In the alternative, the transmitter of the central unit is a wireless transmitter, configured to transmit radio frequency signals towards the plurality of moveable devices.

According to another embodiment, the central unit is further provided with a charger, adapted to charge one or more of the plurality of moveable devices.

In accordance with still another embodiment, the moveable devices are members selected from a group that consists of robots, drones and any combination thereof.

According to another aspect of the disclosure, there is provided a method for reducing interferences between optical depth sensors in a system that comprises a central unit and a plurality of moveable devices, where each of the plurality of moveable devices comprises at least one optical depth sensor, the method comprises the steps of:

establishing a time frame within which at least two of the plurality of optical depth sensors operate, and wherein the time frame comprises a plurality of time slots, each allocated for operation of a respective optical depth sensor;

transmitting by the central unit signals towards the plurality of moveable devices, wherein the signals identify a base time for the operation of the moveable devices, a number of time frames to be implemented within a pre-defined period of time, and time slots within the time frames allocated to each of the moveable devices; and

upon receiving the signals transmitted by the central unit, each of the plurality of moveable devices adjusts its own time base to the one provided by the central unit and synchronizes its operational time slot to the one allocated for its operation.

In accordance with this aspect of the disclosure, the method provided further comprises a step by which the central unit identifies specific moveable devices based on information comprised in barcodes associated with the specific moveable devices.

### BRIEF DESCRIPTION OF THE DRAWINGS

For a more complete understanding of the present invention, reference is now made to the following detailed description taken in conjunction with the accompanying drawing wherein:

FIG. 1—illustrates a schematic presentation of a system construed in accordance with an embodiment of the present invention;

FIG. 2—illustrates a schematic presentation of an embodiment of a central platform comprised in the system depicted in FIG. 1; and

FIG. 3—presents a method for carrying out an example of mitigating interferences between optical sensors comprised in moveable devices of the system depicted in FIG. 1.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

One of the problems addressed by the present disclosure is a problem that arises in different cases, among which, when devices that comprise active optical depth sensors are moving within a confined space, for example robots or drones in a warehouse. In such a case, the projection modules which operate, each in a respective active optical depth sensor, interfere with the sensing capabilities of the other, which in turn results in errors that occur in determining for example the location of the moving devices and the objects located in their vicinity.

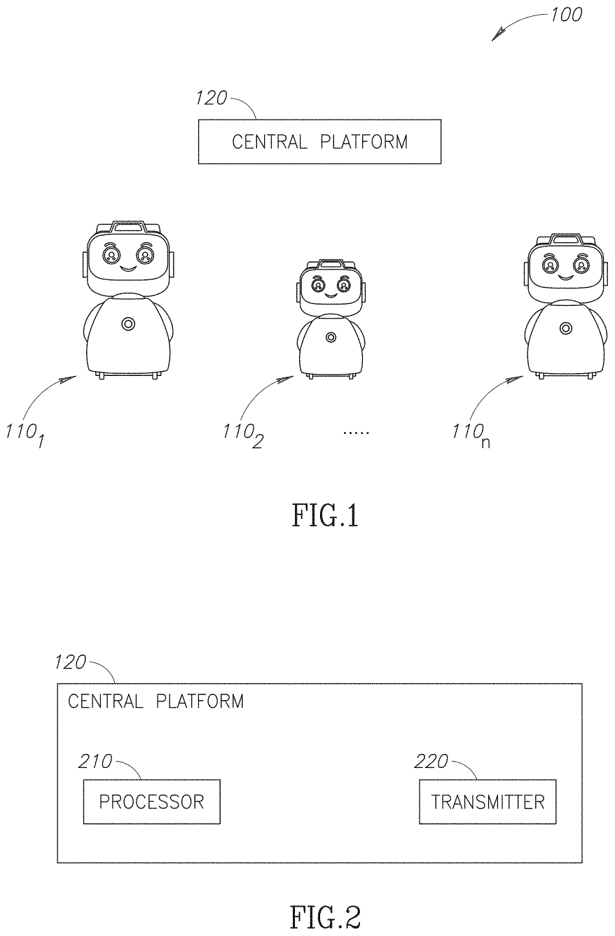

FIG. 1 illustrates a schematic presentation of a system construed in accordance with an embodiment of the present invention. System 100 illustrated in this figure comprises a plurality of robots 110₁, 110₂ . . . , 110ₙ (moveable devices) which are operative within a confined space such as a warehouse (not shown in this figure) System 100 further comprises a central platform (a.k.a. a central unit) 120 that is configured to manage and synchronize the operations of the optical sensors in a way that reduces substantially any possible interference which might otherwise occur due to the operation of the optical sensors of the moveable objects while being located adjacent to each other.

A more detailed schematic view of the central platform 120 is illustrated in FIG. 2, and one of the optional ways it may operate is described in the following disclosure.

Based on the number of robots 110₁ to 110ₙ, processor 210 of central platform 120 is configured to determine the length of the time frame during which every robot will operate once. This one time operation per time frame of a certain robot, will be carried out during a time slot that has been allocated for that robot, wherein the time slot is selected from among a number of time slots comprised in that time frame. Thus, once the length of the time frame has been determined, it is divided into a plurality of time slots, each allocated for the operation of another robot.

However, as will be appreciated by those skilled in the art, the above disclosure is merely an example demonstrating an embodiment of the invention, and other options may be exercised. For example, the length of the time frame may be fixed so that it will not be determined by processor 210. In this case, the processor determines the time slots and allocates them to respective robots. Another option may be for example that the time slots comprised within a single time frame are not equal in their duration, so that the operational time slot allocated to a certain robot may be shorter from the operational time slot allocated to another robot, e.g., depending on the tasks which these specific robots should carry out. By another alternative, one time slot may be allocated to two or more robots, e.g., in a case where they all operate at such a distance from each other, that ensures that there will be no interferences when their optical sensors when operating simultaneously.

Then, processor 210 establishes a starting point for the time frame, and synchronizes that starting point for all robots. The synchronization of the time frame starting point can be done in any one of a number of ways, for example by using transmitter 220 to broadcast a message to all operative robots. Alternatively, it can be done by establishing a communication link between central platform 120 and a specific robot out of robots 110₁, 110₂ . . . , 110ₙ. The link may a wireless link, or alternatively a physical link when the specific robot accesses central platform 120. The establishment of such a communication link may be affected once every pre-defined time period, for example it may be affected between once an hour to once a day, typically, depending on the drift of the robot's clock.

Preferably, processor 210 is configured to determine a combination for the rate of the time frames and the robot's operational times (exposure times) that will enable the splitting a the frame time slots between the plurality of sensors. In order to demonstrate the above, let us assume that for 10 operational robots and for a frame rate of 20 time frames per second, time frames of 50 msec each are determined. In each 50 msec time frame of this example, a 5 msec time slot is allocated to each one of the 10 robots. Out of the 5 msec allocated for each robot, a 4 msec period is available for the operation of that robot's optical sensor, and the remaining 1 msec cut of the 5 msec allocated time slot, is used as a slack time, i.e., the amount of time a task can be delayed without causing the operation of another robot to be delayed.

Still, there are some challenges with the implementation of the above disclosure, mainly, the synchronization of the time base for the various operative robots and overcoming the problem of time drifts that occur while the different robots operate.

As described hereinabove, the present solution offers a number of ways to overcome these problems, among which is the establishment of communication link between the robots and the central platform. The communication link may be affected by having each robot access the central platform every predefined period of time (e.g., every hour, every day, etc.) where the central platform identifies the robot (e.g., by a barcode associated therewith) and provides the robot with information required for its operation. Alternatively, the communication link may be established by transmitting broadcast messages to all the robots, from which each robot ma retrieve information that is shared by all robots (e.g., time frame starting point) and optionally information directed to that robot specifically (such as information that relates to its time slot allocation). This can be done for example, by including in the broadcasted message, the robot's identification followed by information that is destined to that robot.

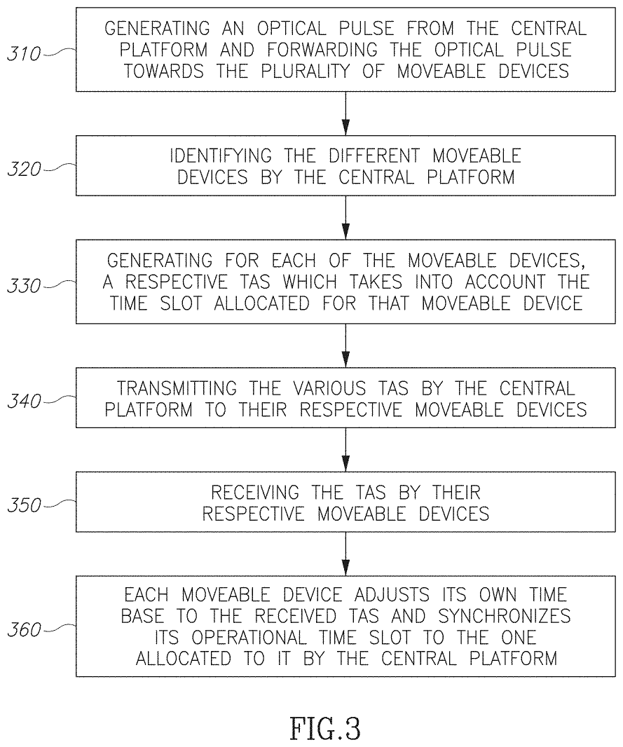

FIG. 3 demonstrates a flow chart of an example of a method construed in accordance with an embodiment of the present invention.

First, at the central platform an optical pulse is generated and forwarded towards moveable devices. Optionally, the optical pulse is at the frequency of the number of time frames per second (fps) implemented in the system for the operation of the moveable devices. The optical pulse will typically have a Near Infra-Red (NIR) wavelength. This optical pulse is then utilized by the different moveable devices as a time alignment signal (step 310).

The central platform identifies the different moveable devices (e.g., by the barcodes associated with them) (step 320) and generates for each moveable devices its respective time alignment signal (hereinafter “TAS”) which takes into account the corresponding time slot allocated for the optical depth sensor of the respective moveable device (step 330).

The respective TAS are transmitted by the central platform to the various moveable devices (step 340) and upon receiving a TAS transmitted by the central platform (step 350), each of the plurality of moveable devices adjusts its own time base to the TAS provided for it by the central platform (e.g., by using its voltage-controlled oscillator (VCO)) and synchronizes its operational time slot to the one allocated for its operation by the central platform (step 360).

At this point, the moveable devices are able to operate within the confined space, without being subjected to optical interferences that will adversely affect their operation.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A central unit configured to operate in a system that comprises a plurality of moveable devices, each comprising at least one optical depth sensor,
wherein the central unit is characterized in that it comprises at least one processor adapted to establish a time frame within which at least two of the plurality of optical depth sensors, operate, and wherein said time frame comprises a plurality of time slots, each allocated for operation of a respective optical depth sensor.

2. The central unit of claim 1, wherein said at least one processor is configured to establish a number of time frames per second, a length of each time frame and a number of the plurality of time slots.

3. The central unit of claim 1, wherein said at least one processor is further configured to synchronize operation of the plurality of optical depth sensors in accordance with the plurality of allocated time slots.

4. The central unit of claim 3, further comprising a transmitter configured to enable communication between the plurality of moveable devices and said central unit in order to enable improved performance of said moveable devices.

5. The central unit of claim 4, wherein the communication between the plurality of moveable devices and said central unit is adapted to enable synchronizing a start of time frames for the plurality of moveable devices and to overcome time drifts while operating said plurality of moveable devices.

6. The central unit of claim 5, wherein the communication between each of the plurality of moveable devices and said central unit is established every pre-defined period.

7. The central unit of claim 6, wherein once communication is established between the central unit and one of the plurality of moveable devices, the central unit is configured to identify a moveable device being in communication with the central unit.

8. The central unit of claim 6, wherein communications are broadcasted by the central unit to the plurality of moveable devices and wherein each of said communications includes an identification of a specific moveable device and information required for the operation of that specific moveable device.

9. The central unit of claim 4, wherein the transmitter is an optical transmitter, configured to transmit optical signals towards the plurality of moveable devices.

10. The central unit of claim 4, wherein the transmitter is a wireless transmitter, configured to transmit radio frequency signals towards the plurality of moveable devices.

11. The central unit of claim 1, further provided with a charger, adapted to charge one or more of the plurality of moveable devices.

12. The central unit of claim 1, wherein said moveable devices are members selected from a group that consists of robots, drones and any combination thereof.

13. A method for mitigating interferences between optical depth sensors in a system that comprises a central unit and a plurality of moveable devices, where each of the plurality of moveable devices comprises at least one optical depth sensor, the method comprises the steps of:
establishing a time frame within which at least two of the plurality of optical depth sensors operate, and wherein said time frame comprises a plurality of time slots, each allocated for operation of a respective optical depth sensor;
transmitting, by the central unit, signals towards the, plurality of moveable devices, wherein the signals identify a base time for the operation of the moveable devices, a number of time frames to be implemented within a pre-defined period of time, and time slots within the time frames allocated to each of the moveable devices; and
upon receiving the signals transmitted by the central unit, each of the plurality of moveable devices adjusts its own time base to the one provided by the central unit and synchronizes its operational time slot to the one allocated for its operation.

14. The method of claim 13, further comprising a step wherein said central unit is configured to identify specific moveable devices based on information comprised in barcodes associated with said specific moveable devices.
